(19) United States
(12) Patent Application Publication
(10) Pub. No.: US 2012/0080389 A1
(43) Pub. Date: Apr. 5, 2012

(54) SOx REMEDIATION IN MANUFACTURING OPERATIONS

(75) Inventors: Steven Thomas SMITH, Fairfax Station, VA (US); Piyush S. SHAH, Houston, TX (US); John D. MILLER, Katy, TX (US); David PERRY, Alexandria, VA (US)

(73) Assignee: EXXONMOBIL RESEARCH AND ENGINEERING COMPANY, Annandale, NJ (US)

(21) Appl. No.: 13/216,838

(22) Filed: Aug. 24, 2011

Related U.S. Application Data
(60) Provisional application No. 61/388,355, filed on Sep. 30, 2010.

(51) Int. Cl. B01D 53/77; B01J 19/00

(52) U.S. Cl. 210/759; 422/168; 422/170; 210/758

(57) ABSTRACT

Method for SOx remediation in a manufacturing operation includes providing a process stream including an organic compound and an amount of a sulfur-containing compound, an oxidation stream including at least one chemical oxidant, and combining at least a portion of the oxidant stream with at least a portion of the process stream to obtain an organic stripper feed stream, in which the amount of the sulfur-containing compound is reduced upon reaction with the at least one chemical oxidant. The method can further include directing at least a portion of the organic stripper feed stream to a combustion operation, and emitting a SOx remediated off gas from the combustion operation. A system using the disclosed method also is provided.

### CROSS REFERENCE TO RELATED APPLICATIONS

This application relates and claims priority to U.S. Provisional Patent Application No. 61/388,355, filed on Sep. 30, 2010.

### FIELD OF THE PRESENTLY DISCLOSED SUBJECT MATTER

The presently disclosed subject matter relates to methods and systems to oxidize sulfur-containing compounds in aqueous process streams that also contain flammable organic compounds. In certain embodiments, SOx remediation is provided by converting sulfur-containing compounds found in the process stream upstream from a combustion operation. The presently disclosed subject matter also relates to methods and systems for the reduction of sulfide emissions in the event that the stripper vents to either the atmosphere or to activated carbon.

### BACKGROUND OF THE PRESENTLY DISCLOSED SUBJECT MATTER

Increasingly stringent environmental regulations have been enacted world-wide in an effort to reduce the emission of pollutant gases into the atmosphere from combustion equipment used by numerous unit operations within a manufacturing operation. Of particular concern is the emission of sulfur oxides (SOx). To address this, regulators have limited the H₂S content that may be present in any fuel gas (which is defined as any gas that is generated in a manufacturing plant (e.g., a refinery) and combusted) burned in any fuel gas combustion device within the a manufacturing plant such as a refinery.

Combustion operations in manufacturing applications, such as chemical processing and petrochemical refining operations, are commonly used to convert unwanted impurities in process streams to less harmful combustion products. During the combustion process, sulfides and other sulfur-containing compounds present in the process stream react with oxygen within a combustion chamber, under the high temperature and pressure conditions that typically exist therein, and sulfur oxides (SOx) are produced.

Commercial techniques used for SOx remediation are generally directed to the off gas stream itself. For example, the incinerator outlet gas stream is often scrubbed with a caustic stream. There remains a need, however, for improved methods and apparatus for removing SOx from the off gas stream of a combustion device, particularly those found in chemical processing and/or petrochemical refining operations. There is a need for removing SOx from the stream prior to combustion.

### SUMMARY OF THE PRESENTLY DISCLOSED SUBJECT MATTER

In contrast to conventional methods of SOx remediation that focus only on the off gas from combustion operations, SOx remediation can instead be efficiently achieved by removing precursors to SOx before reaching the combustion device.

Accordingly, one aspect of the presently disclosed subject matter provides a method for SOx remediation in a manufacturing operation that includes providing an aqueous process stream including an organic compound, which is preferably flammable and an amount of a sulfur-containing compound, providing an oxidation stream including at least one chemical oxidant, and combining at least a portion of the oxidant stream with at least a portion of the process stream to obtain a stripper feed stream, which is preferably an organic contaminated aqueous stripper feed stream, in which the amount of the sulfur-containing compound is reduced upon reaction with at least one chemical oxidant. The method can further include introducing at least a portion of the stripper feed stream into a combustion operation, and emitting a SOx remediated off gas from the combustion operation.

Another aspect of the presently disclosed subject matter provides a SOx remediation system for a manufacturing operation that includes an aqueous process stream including an organic compound and an amount of a sulfur-containing compound, a source of at least one chemical oxidant, a reaction vessel adapted to receive at least a portion of the process stream and at least a portion of the at least one chemical oxidant to obtain an organic contaminated aqueous stripper feed stream, wherein the amount of the sulfur-containing compound is reduced upon reaction with the at least one chemical oxidant. The system can further include a combustion device adapted to receive at least a portion of the stripper feed stream to emit a SOx-remediated off gas.

### BRIEF DESCRIPTION OF THE DRAWINGS

FIG. 1 is schematic representation of a process diagram of a benzene removal operation within a petroleum refinery.

### DETAILED DESCRIPTION OF THE PRESENTLY DISCLOSED SUBJECT MATTER

### Definitions

As used herein, the term “SOx” refers to either one, or a combination of, sulfur oxides and include, but are not limited to, SO, SO₂, SO₃, SO₄, S₇O₂ and S₆O₂.

As used herein, the term “SOx remediation” refers to a process or system to reduce the amount of SOx emitted from a combustion operation to the atmosphere, as compared to the similar process or system that does not contain or otherwise include the SOx control efforts described in connection herewith.

As used herein, the term “SOx remediated off gas” refers to a process stream or system stream in which the amount of SOx emitted from a combustion operation to the atmosphere is reduced upon, as compared to the similar process stream or system stream that does not contain SOx remediation.

As used herein, the term “combustion operation” refers to a unit operation within a manufacturing operation in which a combustion reaction occurs. A combustion operation can include, but is not limited to, the operation of a furnace, incinerator, thermal oxidizer, boiler, heater and a gas turbine.

As used herein, the term “sulfide” refers to a compound that includes an S²⁻ anion. Examples, of sulfides, include, but are not limited to, hydrogen sulfide (H₂S), cadmium sulfide (CdS), carbon disulfide (CS₂), carbonyc sulfide (COS), lead sulfide (PbS), sodium sulfide (Na₂S), inorganic metal sulfides (e.g., FeS), ammonium polysulfide and any cation accompanying the S⁻² anion.

As used herein, the term “thiol” refers to a compound represented by the formula R—S—H, wherein H is hydrogen and R is an organic group (e.g. an alkyl group) such as, for example, methyl CH₃SH and ethyl C₂H₅SH.

As used herein, the term “GHSV” refers to term “gaseous hourly space velocity” and is the ratio of the gaseous volumetric flow rate, at standard conditions of 60° F. and one atmosphere of pressure, to the reactor volume.

As used herein, the term “manufacturing operation” refers to any operation in which a commodity (e.g., electricity), chemical, petroleum or other article of commercial interest (including a chemical intermediate to an article of commerce interest) is manufactured, produced refined, or otherwise provided. In one embodiment, the article of commercial interest is manufactured, produced or otherwise provided in an industrial scale.

As used herein, a “chemical oxidant” refers to a molecule that can generate free reactive oxygen such that it can either transfer one or more oxygen atoms to a second molecule (i.e., a sulfur-containing compound such as hydrogen sulfide.), or a molecule that gains electrons in a redox chemical reaction. For example, the chemical oxidant hydrogen peroxide (H₂O₂), upon reaction with hydrogen sulfide under certain conditions, donates an oxygen atom to the hydrogen sulfide to yield water and elemental sulfur:

H₂S+H₂O₂→S+2H₂O (I).

Under alkaline conditions, the product content varies. With pH greater than 9.2, the product content is 100% SO₄ ions. The following reaction primarily occurs:

Na₂S+4H₂O₂→Na₂SO₄+4H₂0 (II)

Hydrogen peroxide can also react with a thiol according to the following reaction scheme to yield water and an organic sulfonic acid:

RSH+3H₂O₂→RS(═O)₂OH+3H₂O (III).

Oxygen itself can also be used as a chemical oxidant in accordance with the methods of the present application. Upon reaction with a thiol, oxygen donates an oxygen atom to yield a dialkyl dissulfide and water:

2RSH+½O₂=>RSSR+H₂O (IV).

Another example of a chemical oxidant is ozone, which can donate on oxygen atom to a thiol to yield water and an organic sulfonic acid:

RSH+3O₃=>RS(═O)₂OH+3O₂ (producing an organic sulfonic acid) (V).

Additional chemical oxidants besides hydrogen peroxide, oxygen and ozone include, but are not limited to, sodium hypochlorite, permanganate, fluorine, chlorine and chlorine dioxide.

As used herein, the term “provided in an industrial scale” refers to a manufacturing operation in which, for example, gasoline or other product of commercial interest is produced on a generally continuous basis (with the exception of necessary outages for plant maintenance or upgrades) over an extended period of time (e.g., over at least a week, or a month, or a year) with the expectation of generating revenues from the sale or distribution of the product of commercial interest. Production on an industrial scale is distinguished from laboratory or pilot plant settings, which are typically maintained only for the limited period of the experiment or investigation, and are conducted for research purposes and not with the expectation of generating revenue from the sale or distribution of the end product produced thereby.

As used herein, a “desalting operation” refers to a process within a petroleum refining operation in which water is introduced to, and later separated from, crude oil for the purpose of removing water-soluble impurities (e.g., inorganic salts, water in the crude oil, and solid particles) from the crude oil. Often, but not necessarily, the water is introduced to the crude oil and an emulsion is formed to provide intimate contact between the crude oil and water. In certain embodiments of the presently disclosed subject matter, a desalting operation aqueous exit stream (or brine) containing a sulfur-containing compound and an organic compound provides an aqueous process stream for SOx remediation.

As used herein, the term “desalter” refers to a device within a desalting operation in which crude oil and water are separated. The desalter can separate the crude oil from the water by any means known in the art, including, but not limited to, use of surfactants, demulsifiers and/or a high-voltage electrostatic field to cause the droplets of water to coalesce.

As used herein, the term “flammable organic compound” refers to a carbon-containing compound that can be disposed of (e.g., converted to another compound) in a combustion operation (e.g., an incinerator, furnace or thermal oxidizer). Often, but not necessarily, the combustion products of a flammable organic compound are less deleterious than the flammable organic compound itself. Flammable organic compounds include, but are not limited to, aromatic hydrocarbons (e.g., benzene, toluene, ethylbenzene and xylenes), VOCs, MTBE (methyl tertiarybutyl ether) and other contaminants that can be converted to less harmful or more desirable products upon being combusted.

Reference will now be made to various aspects of the present application in view of the definitions above.

In accordance with the presently disclosed subject matter, a method is provided for SOx remediation in a manufacturing operation. The method includes providing an aqueous process stream including an organic compound and an amount of a sulfur-containing compound (e.g., a sulfide, such as hydrogen sulfide), providing an oxidation stream including at least one chemical oxidant, and combining at least a portion of the oxidant stream with at least a portion of the aqueous process stream to obtain a stripper feed stream, which is preferably an organic stripper feed stream, in which the amount of the sulfur-containing compound is removed or converted upon reaction with the at least one chemical oxidant. The method can further include directing at least a portion of the stripper feed stream to a combustion operation (e.g., an incinerator or flare stack), and emitting a SOx remediated off gas from the combustion operation. The SOx remediated off gas can be directly released to the atmosphere, or alternatively subjected to further pollution remediation efforts and then released to the atmosphere.

In one embodiment the flammable organic compound present in the aqueous process stream for which SOx remediation is desired includes an aromatic hydrocarbon, such as benzene, toluene, ethylbenzene and xylenes.

The amount of the organic compounds present in the process stream can vary. In one embodiment, the process stream contains at least about 10 wppm of the flammable organic compound (e.g., aromatic hydrocarbon). For certain embodiments in which the process stream contains benzene, the process stream can contain about 20,000 wppm of hydrocarbon, but preferably less than 100 wppm of benzene and less than 1000 wppm of hydrocarbon.

The process stream can be any process stream within a manufacturing operation that contains an organic compound and an amount of sulfur-containing compound. In one particular embodiment, the process stream is obtained from a desalting process. In an alternative embodiment, the process stream is obtained from, for example, NH₃-rich streams from sour water strippers, process vent gas streams from various sources, such as from vacuum distillation operations, sulfur pits, alkylation units, etc.), hydrocarbon water tank drains, and oil/water or oil/water/gas separation product water streams.

The sulfur-containing compound can be, for example, a sulfide or a thiol. In one particular embodiment, the sulfur-containing compound is hydrogen sulfide. The present invention is not intended to be limited to hydrogen sulfides; rather, other sulfides are considered to be well within the scope of the present invention including but not limited to cadmium sulfide (Cdₛ), carbonyc sulfide (COS), carbon disulfide (CS₂), lead sulfide (PbS), sodium sulfide (Na₂S), inorganic metal sulfides (e.g., FeS) and any cation accompanying the S⁻² anion.

In one embodiment, the oxidation stream includes at least one chemical oxidant selected from hydrogen peroxide, sodium hypochlorite, permanganate, oxygen, ozone, fluorine, chlorine and chlorine dioxide. In one embodiment, the chemical oxidant is hydrogen peroxide.

In various embodiments, oil is further removed the aqueous process stream either before or after chemical oxidation and prior to the stripping operation. In various embodiments, the organic stripper feed stream is introduced to a stripper device to isolate the organic compound in the organic stripper feed stream, and an overhead output stream of the stripper device is introduced to the combustion operation. The overhead output stream generally contains the flammable organic compound and is often in gaseous form. The stripper device can also receive a feed of air or fuel which is used to isolate the flammable organic compound and is generally directed to the overhead output stream of the stripper device. Because the sulfur-containing compound has been removed from the organic stripper feed stream upstream from the combustion device (i.e., converted to another compound that does not convert to SOx), the sulfur-containing compounds are not converted to SOx, and SOx remediation is thereby provided upon combusting the flammable organic compound in a combustion operation.

In certain embodiments, a portion of the stripper reduced stream is condensed to become hydrocarbons prior to combustion. In certain embodiments, the portion of the stripper feed stream that is directed to the combustion operation (e.g., the overhead stream from a stripper device) contains less than 160 vppm of sulfur-containing compound (e.g., hydrogen sulfide) upon being introduced to the combustion operation. In accordance with the process and system of the present invention, the H₂S concentration is significantly reduced below 160 vppm prior to introduction in the combustion device. The concentration can be below 5 vppm. Furthermore, the sulfide conversion is greater than 90% and typically greater than 95%.

Another aspect of the presently disclosed subject matter provides a SOx remediation system for a manufacturing operation that includes a process stream including an organic compound and an amount of a sulfur-containing compound, a source of at least one chemical oxidant, a reaction vessel adapted to receive at least a portion of the process stream and at least a portion of the at least one chemical oxidant to obtain an organic stripper feed stream, in which the amount of the sulfur-containing compound is reduced upon reaction with the at least one chemical oxidant. The system can further include a combustion device adapted to receive at least a portion of the organic stripper feed stream to emit a SOx-remediated off gas.

Additional features and embodiments of the SOx remediation system can be obtained from the description of the SOx remediation process.

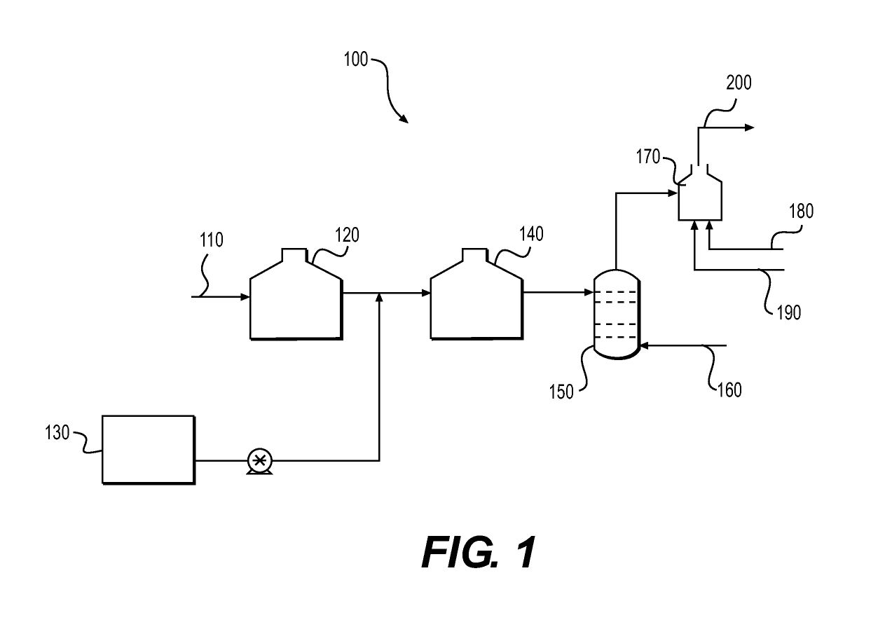

Particular aspects of the method and system are described further below with reference to the exemplary embodiment depicted schematically in FIG. 1 for purpose of illustration, and not limitation.

For example, and as shown in FIG. 1, benzene and other organic compounds are ultimately consumed in a combustion operation that emits to the atmosphere reduced amounts of SOx. An aqueous process stream (110) is provided from the water/brine effluent stream of a desalter which contains benzene, a known carcinogen and hydrogen sulfide, a precursor to SOx. Process streams containing other organic compounds, such as, but not limited to, toluene, ethylbenzene, xylenes or VOCs from other sources besides desalters can also be treated according to the presently disclosed subject matter.

The process stream may be directed to an oil removal tank (120) to separate out oil remaining in the brine effluent stream. In accordance with one embodiment of the present invention, the oxidant is a hydrogen peroxide solution. A supply of hydrogen peroxide (130) is provided and introduced to the brine effluent stream. It is contemplated that the supply may be introduced into an oil removal tank or directly to the desalter brine stream. In accordance with one embodiment of the present invention, the hydrogen peroxide solution is a 50% hydrogen peroxide solution (in water) may have the following properties: apparent pH<3; 23.5% active O₂ content; 1.20 specific gravity (20° C.); and 10 pounds per gallon (20° C.). While it is contemplated that the supply will thoroughly contact the stream, a separate mixer is not required. The present invention is effective without separately mixing the supply with the stream. The oxidant, however, should be distributed into the process stream through a suitable injection quill at a velocity that will help promote the natural dispersing and contacting of the oxidant and the aqueous stream. Downstream from the introduction of hydrogen peroxide an equalization/reaction tank (140) is provided to provide additional residence time for any hydrogen sulfide present in the process stream to react with the hydrogen peroxide to yield water and elemental sulfur or water and Na₂SO₄ depending on the pH of the aqueous stream. The oxidation of sulfides with hydrogen peroxide proceeds differently, depending primarily on the pH of the wastewater. Hydrogen peroxide reacts with sulfides under acidic, neutral and alkaline conditions. Under acidic conditions, the product is predominantly elemental sulfur. The following reaction occurs:

H₂S+H₂0₂→S+2H₂0

Under alkaline conditions, the product content varies. With pH greater than 9.2, the product content is 100% SO₄ ions. The following reaction primarily occurs:

Na₂S+4H₂0₂→Na₂S0₄+4H₂0

With pH between 8 and 9.2, the product content is predominantly SO₄ ions with some elemental sulfur. With pH between 7 and 8, the product content is SO₄ ions and elemental sulfur. Both of the above reactions occur. The use of hydrogen peroxide in the process of the present invention is attractive for several reasons. It adds only water and oxygen to the environment. It does not create any additional pollution issues because the present process yields elemental sulfur and/or a soluble sulfate ion. Other chemical oxidants besides hydrogen peroxide, include but are not limited to sodium hypochlorite, permanganate and others as described above can also be used and are considered to be well within the scope of the present invention. Regardless of the pH, the process in accordance with the present invention can achieve 100% sulfide conversion with a relatively short reaction time (minimum required reaction time between 1 and 50 minutes).

From the equalization/reaction tank, the stream is directed to a benzene stripper (150) in which air (160) is fed to the stripper along with the process stream. Additionally or alternatively, fuel gas, for example, can be used to strip the benzene from process stream. The present invention is not intended to be limited to fuel gas; rather, other gases including nitrogen and steam are considered to be well within the scope of the present invention. Instead of a stripper, other separation devices can be employed to isolate the flammable organic compound, preferably in gaseous form, which can be fed, with or without further processing, to a combustion device.

Benzene is removed from the process stream from the overhead of the stripper and directed to an incinerator or flare stack (170) or the like, which also receives a feed of air (180) and a fuel, such as methane (190), where the benzene is combusted. The incinerator emits an off gas (200) to the atmosphere. Because hydrogen sulfide, which converts to SOx under combustion conditions, was removed upstream of the combustion operation, the amount of SOx released to the atmosphere is reduced. Optionally, the incinerator off gas can be directed to further pollution remedial operations (e.g. NOx and/or SOx remediation operations) prior to being released to the atmosphere.

The presently disclosed subject matter is not to be limited in scope by the specific embodiments described herein. Indeed, various modifications of the invention in addition to those described herein will become apparent to those skilled in the art from the foregoing description and the accompanying figures. Furthermore, the teachings of the prior art can be used to supplement the SOx remediation processes and systems described herein. For example, U.S. Pat. No. 7,389,638 discloses a sulfur oxide/nitrogen oxide trap system and method for the protection of nitrogen oxide storage reduction catalyst from sulfur poisoning. U.S. Pat. No. 7,074,979 discloses a process to treat a contaminated oxygenate-containing feed stream in an oxygenate to olefin reaction system. U.S. Pat. No. 6,610,264 discloses a process and system for desulfurizing a gas stream. U.S. Pat. No. 4,956,161 discloses a gas desulfurization process to produce a gaseous product having a decreased content of sulfur oxides and a decreased appearance of blue haze. U.S. Pat. No. 4,407,206 discloses a partial combustion process for coal. U.S. Pat. No. 4,029,752 discloses a method for reducing sulfur dioxide in which ammonia is used as a reducing agent. The contents of these disclosures are incorporated by reference for all purposes, including disclosure in these disclosures related to supplemental SOx/NOx remediation efforts that can be used in addition to the disclosed subject matter, and operating parameters for SOx remediation processes in general.

It is further to be understood that all values are approximate, and are provided for description.

Patents, patent applications, publications, product descriptions, and protocols are cited throughout this application, the disclosures of each of which is incorporated herein by reference in its entirety for all purposes.

1. A method for SOx remediation in a manufacturing operation comprising:
providing an aqueous process stream including an organic compound and an amount of a sulfur-containing compound;
providing an oxidation stream including at least one chemical oxidant; and
combining at least a portion of the oxidant stream with at least a portion of the aqueous process stream to obtain a stripper feed stream, wherein the amount of the sulfur-containing compound is reduced upon reaction with the at least one chemical oxidant;.

2. The method of claim 1, further comprising:
introducing at least a portion of the stripper feed stream eventually into a combustion operation; and
emitting a SOx remediated off gas from the combustion operation.

3. The method of claim 1, wherein the organic compound includes an aromatic hydrocarbon.

4. The method of claim 1, wherein the organic compound is a flammable organic compound.

5. The method of claim 3, wherein the aromatic hydrocarbon includes benzene.

6. The method of claim 1, wherein the sulfur-containing compound is selected from a sulfide and a thiol.

7. The method of claim 6, wherein the sulfur-containing compound is hydrogen sulfide.

8. The method of claim 1, wherein the aqueous process stream is from a desalting process.

9. The method of claim 1, wherein the aqueous process stream is obtained from one of NH₃ rich streams, process vent gas streams and oil/water or oil/water/gas separation product water streams.

10. The method of claim 1, wherein the oxidation stream includes at least one chemical oxidant selected from hydrogen peroxide, sodium hypochlorite, permanganate, oxygen, ozone, fluorine, chlorine and chlorine dioxide.

11. The method of claim 10, wherein the chemical oxidant includes hydrogen peroxide.

12. The method of claim 2, wherein the stripper feed stream is introduced to a stripper device to isolate the organic compound in the stripper feed stream, and an overhead output stream of the stripper device is introduced to the combustion operation.

13. The method of claim 12, wherein the overhead output stream of the stripper device is in gaseous form.

14. The method of claim 13, wherein the stripper device is in fluid communication with a second stream selected from air and fuel.

15. The method of claim 2, wherein introducing at least a portion of the stripper feed stream into a combustion operation includes introducing at least a portion of the stripper feed stream into an incinerator.

16. The method of claim 2, wherein the SOx remediated off gas is directed to the atmosphere.

17. The method of claim 2, wherein the SOx remediated off gas is directed to a second pollution remediation operation, and subsequently directed to the atmosphere.

18. A SOx remediation system in a manufacturing operation comprising:
a process stream including an organic compound and an amount of a sulfur-containing compound;
a source of at least one chemical oxidant; and
a reaction vessel adapted to receive at least a portion of the process stream and at least a portion of the at least one chemical oxidant to obtain a stripper feed stream, wherein the amount of the sulfur-containing compound is reduced upon reaction with the at least one chemical oxidant.

19. The system of claim 18, further comprising: a combustion device adapted to receive at least a portion of the stripper feed stream to emit a SOx remediated off gas.

20. The system of claim 18, wherein the organic compound includes an aromatic hydrocarbon.

21. The system of claim 20, wherein the aromatic hydrocarbon includes benzene.

22. The system of claim 20, wherein the organic compound is flammable.

23. The system of claim 18, wherein the sulfur-containing compound is selected from a sulfide and a thiol.

24. The system of claim 23, wherein the sulfur-containing compound is hydrogen sulfide.

25. The system of claim 18, further comprising a desalter adapted to provide a source of the process stream exiting the desalter.

26. The system of claim 18 wherein the source of at least one chemical oxidant includes at least one chemical oxidant selected from hydrogen peroxide, sodium hypochlorite, permanganate, oxygen, ozone, fluorine, chlorine and chlorine dioxide.

27. The system of claim 26, wherein the chemical oxidant includes hydrogen peroxide.

28. The system of claim 19, further comprising a stripper device to isolate the organic compound in the organic stripper feed stream, adapted to provide an overhead output stream to be introduced to the combustion device.

29. The system of claim 28, further comprising a second stream selected from air and fuel in fluid communication with the stripper device.

30. The system of claim 19, further including a second pollution remediation device adapted to receive at least a portion of the SOx remediated off gas exiting the combustion device.
